(19) United States
(12) Patent Application Publication
(10) Pub. No.: US 2002/0059651 A1
(43) Pub. Date: May 16, 2002

(54) Multi-broadcast receiving and distributing device

(76) Inventors: Kohzoh Hirata, Osaka (JP); Yoichi Ohgami, Yamatotakada-shi (JP); Akira Shibata, Yamatokoriyama-shi (JP)

Correspondence Address: BIRCH STEWART KOLASCH & BIRCH, PO BOX 747, FALLS CHURCH, VA, 22040-0747, US

(21) Appl. No.: 09/946,515

(22) Filed: Sep. 6, 2001

(30) Foreign Application Priority Data
Aug. 18, 2000 (JP) 2000-317767

(51) Int. Cl. H04N 7/16

(52) U.S. Cl. 725/153

(57) ABSTRACT

A system for viewing broadcasts from a plurality of different broadcasting companies at a plurality of desirable places can be easily constructed. A multi-broadcast receiving and distributing device comprises a plurality of receivers #1, #2 and #3 each of which has a receiving portion for receiving and extracting inherent carrier signals and a signal converting portion for converting the carrier signals into common signal type baseband signals respectively, and a device body having a plurality of spaces for accommodating the receivers #1, #2 and #3 respectively and outputting the baseband signals therefrom, a signal processing means for generating digital signals by processing the baseband signals from the spaces #1, #2 and #3 respectively, a program selecting portion for selectively outputting one of the digital signals, which is relevant to a particular broadcast program, and a program transmitting portion for transmitting the selected output signal to a plurality of display units.

### BACKGROUND OF THE INVENTION

The present invention relates to a multi-broadcast receiving and distributing device capable of receiving a plurality of signals broadcast by broadcasting companies and distributing the received signals to a plurality of display units, and more specifically to a multi-broadcast receiving and distributing device capable of accommodating therein a plurality of receivers for receiving carrier signals of particular broadcast programs or data from a plurality of broadcasting companies, converting the received carrier signals into baseband signals of a common signal type, outputting the common baseband signals and finally delivering the receiving signals to a plurality of display units.

Conventional broadcasting services are now available as analog terrestrial broadcasts, analog satellite broadcasts, analog CATV broadcasts and digital satellite broadcasts. At present, analog broadcasts are still predominant over digital. However, recent remarkable development of digital transmission techniques facilitates the digitalization of the broadcasts. Furthermore, the above analog broadcasts are gradually being replaced with digital broadcasts (digital CATV broadcast and digital terrestrial broadcast). All analog terrestrial broadcasting systems will be out of service after a certain transition period.

In digital broadcasting, video and audio information (signal) is digitally compressed by MPEG-2 (Moving Picture Experts Group-2) method and transmitted. In comparison with existing analog broadcasting systems, the digital broadcasting systems can transmit higher quality signals, improve a frequency factor and provide multi-channel services. The digital broadcasts not only provide AV information but also carry out data broadcasting services.

Digital satellite broadcast services have now started to provide a number of channels for supplying various contents such as sports, movie, music, news and so on. One satellite can allocate several hundreds channels to TV broadcasting.

Furthermore, digital CATV broadcasts and digital terrestrial broadcasts subsequently start their services. Several new satellites usable for digital satellite broadcasting services have been launched and several digital satellite broadcasting companies are now starting broadcast services. The digital broadcasting services are preparing channels for providing a variety of interesting TV programs.

The above-described circumstances increase the number of subscribers to both of the analog broadcast services and the digital broadcast services so as to enjoy a variety of broadcasting services to be provided.

To receive these digital broadcasts, it is necessary to prepare special receivers “Set Top Box” (hereinafter referred to as STB) for decoding digital video signals and digital voice signals, which are inherent to respective digital broadcasts.

However, these STB are basically needed one for each display unit of each television receiver. Namely, the user can view digital broadcasts to be supplied from a digital broadcasting company only on a display device connected to a STB designated by the company.

Referring to a conventional indoor broadcast reception wiring system shown in FIG. 1, an exemplary conventional method for receiving and distributing digital broadcasts is described bellow. In FIG. 1, numeral 500 designates an indoor wiring system for receiving a plurality of different broadcast signals and distributing the received signals of respective digital broadcasts to a plurality of display devices. Numeral 11 denotes a digital satellite broadcasting company #1 who proves digital broadcast TV programs using a first satellite, 12 a digital satellite broadcasting company #2 who provides digital broadcast TV programs using a second satellite, 13 a digital satellite broadcasting company #3 who provides digital broadcast TV programs using a third satellite, 14 a CATV broadcasting company who provides analog TV programs or digital TV programs for general subscribers over outdoor cable lines such as coaxial cables or fiber optic cables, 15 a digital terrestrial broadcasting company who provides digital TV programs by using terrestrial waves and 17 an analog terrestrial broadcasting company who provides analog TV programs by using terrestrial waves.

11a is a satellite antenna portion for receiving electromagnetic waves from the first satellite, 12a is a satellite antenna portion for receiving electromagnetic waves from the second satellite, 13a is a satellite antenna portion for receiving electromagnetic waves from the third satellite, 15a is a digital terrestrial antenna portion for receiving digital terrestrial broadcasts and 17a is an analog terrestrial antenna portion for receiving analog terrestrial broadcasts.

Numeral 501 designates a mixer for mixing a signal received by the first satellite broadcast receiving antenna portion 11a with a signal received by the analog terrestrial antenna portion 17a and outputting mixed signals into a coaxial cable 510a. Numeral 506 denotes a distributor for distributing the mixed signals transmitted via the coaxial cables 510a to respective coaxial cables 511a, 511b and 511c extending to separate rooms “a”, “b” and “c” respectively. Numeral 502 denotes a distributor for distributing a signal received by the second satellite broadcast receiving antenna portion 12a to coaxial cables 512a and 512b extending to separate rooms “a” and “b” respectively. Numeral 503 denotes a distributor for a signal received by the third satellite broadcast receiving antenna portion 13a to coaxial cables 513a and 513c extending to separate rooms “a” and “c” respectively. Numeral 504 denotes a distributor for distributing a signal received through an outdoor cable 14a from the CATV station to coaxial cables 514a and 514b extending to rooms “a” and “b” respectively. Numeral 505 denotes a distributor for a signal received by the terrestrial broadcast receiving antenna portion 15a to coaxial cables 515a and 515b extending to separate rooms “a” and “b” respectively.

Numerals 411a and 411c designate digital satellite broadcast receiving devices (STBs for satellite #1) located in rooms “a” and “c” respectively for descrambling the first digital satellite broadcasts received by the antenna portion 11a and controlling the selection of a satellite broadcast program channel. 412a and 412b are digital satellite broadcast receiving devices (STB for satellite #2) located in rooms “a” and “b” respectively for descrambling the second digital satellite broadcast received by the antenna portion 12a and controlling the selection of a digital satellite broadcast program channel. Numeral 413a designates a digital satellite broadcast receiving device (STB for satellite #3) located in room “a” for descrambling the third digital satellite broadcast received by the antenna portion 13a and controlling the selection of a digital satellite broadcast program channel. 414a and 414b are CATV broadcast receiving devices (STB for CATV) located in rooms “a” and “b” respectively for descrambling a cable TV broadcast received via an outdoor CATV network cable 14a and controlling the selection of a CATV broadcast program channel. 415a and 415b are digital terrestrial broadcast receiving devices (STB for digital terrestrial broadcast) located in rooms “a” and “b” respectively for descrambling a digital terrestrial broadcast received by the antenna portion 15a and controlling the selection of a digital terrestrial broadcast program channel.

Numerals 521a and 521c denote connection cables for externally inputting output video signal of a first satellite broadcast program descrambled by the STBs 411a and 411c respectively into AV selecting means 420a and 420c arranged in rooms “a” and “c” respectively. Numerals 522a and 522b denote connection cables for externally inputting output video signal of a second satellite broadcast program descrambled by the STBs 412a and 412b respectively into AV selecting means 420a and 420b arranged in rooms “a” and “b” respectively. Numeral 523a denotes a connection cable for externally inputting output video signal of a third satellite broadcast program descrambled by the STB 413a into an AV selecting means 420a arranged in room “a”. Numerals 524a and 524b denote connection cables for externally inputting output video signal of a CATV broadcast program descrambled by the STBs 414a and 414b respectively into AV selecting means 420a and 420b arranged in rooms “a” and “b” respectively. Numerals 525a and 525b denote connection cables for externally inputting output video signals of a terrestrial broadcast programs descrambled by the STBs 415a and 415b respectively into AV selecting means 420a and 420b arranged in rooms “a” and “b” respectively.

Numerals 420a, 420b and 420c designate AV selecting means for changing over displays of television receivers 430a, 430b and 430c disposed in separate rooms “a”, “b” and “c” respectively to display thereon input signals selected respectively from a plurality of externally input video signals. The television receiver #1, 430a has the AV selecting means 420a, the television receiver #2, 430b has the AV selecting means 420b and the television receiver #3, 430c has the AV selecting means 420c.

In constructing the indoor wiring system 500 shown in FIG. 1, the user must prepare STBs and connection cables necessary for newly enjoying a plurality of digital broadcasts in separate rooms “a”, “b”, “c” and “d” in addition to currently receivable analog broadcasts. The necessary procedure will be described bellow:

In the first step, the user installs a plurality of antennas for receiving broadcast signal delivered by respective broadcasting company and/or a plurality of outdoor specified cables to receive and view a plurality of digital broadcasts in addition to currently available analog broadcasts.

In the second step, the user previously determines places (rooms) for viewing specified broadcasts respectively, then connects distributors to respective coaxial cables coupled with the antennas or outdoor cables and connects coaxial cables from respective rooms to the corresponding distributors.

In the third step, the user purchases or leases set top boxes (STB) designated by respective broadcast companies. In this case, if the user intends to enable his/her family members to concurrently enjoy the same broadcast available from the same broadcasting company in different rooms, he/she must purchase or lease a plurality of the same STBs to be placed one in each room.

In the fourth step, the user connects each specified STB to an end of a specified indoor-wiring coaxial cable connected to a specified antenna for receiving broadcasts from each broadcasting company and then connects the STB via a connection cable to a television receiver installed in each room.

On completion of the above steps 1 to 4, broadcast signals to be provided free of charge by particular broadcasting companies can be received and displayed on each of TV sets placed at different indoor places (in separate rooms).

On the other hand, among programs to be provided by each broadcasting company, there may be included chargeable broadcasts that can be received by a so-called qualified reception method. Therefore, it is necessary to make a specified subscription contact in advance to receive the chargeable broadcasts.

In the fifth step, to receive those chargeable broadcasts, the user must conclude a specified subscription contact. Generally, an IC card is used as a means for managing information on the subscription. Every time when the user wants to view a particular chargeable program, he/she has to insert the IC card into a slot of an IC card drive of the particular STB purchased or leased by the user from the particular broadcasting company.

Each broadcasting company provides each user with broadcasts according to the subscription contract as well as separate information (e.g., contract information, individual messages) and broadcast information such as broadcast program guides. Utilizing the STB corresponding the particular broadcasting company, each user receives and records the separate information and the program guide on the IC card inserted therein. Regarding received signals of a chargeable program inputting to the STB, the STB identifies the contract information and the descrambling key, which were read by the IC card drive from the content of the IC card inserted therein, and descrambles and decodes received signal to be displayed on the TV receiver.

In the home wiring system 500 (FIG. 1) constructed by the above-described procedure, the user can enjoy on a TV set in Room “a” six (6) kinds of broadcasting services: first digital satellite broadcast, second digital satellite broadcast, third digital satellite broadcast, CATV broadcast, digital terrestrial broadcast and analog terrestrial broadcast.

On the TV set in Room “b”, the user can enjoy four (4) kinds of broadcasting services: second digital satellite broadcast, CATV broadcast, digital and analog terrestrial broadcast.

On the TV set in Room “c”, the user can enjoy second (2) kinds of broadcasting services: first digital satellite broadcast and analog terrestrial broadcast.

In Room “d”, no broadcast service can be received.

However, the above-described home wiring system for receiving a plurality of different broadcasting services in a plurality of different rooms and the procedure for constructing the same system involve the following problems:

Problem (1): To receive a particular broadcast service, the user, as described before in the second step, has to first designate a place (room) for viewing the broadcast service, extend thereto a coaxial cable connected to a particular antenna provided for receiving the particular broadcast service, connect its free end to a particular STB provided for the particular broadcast service and connect the latter via a connection cable to a TV receiver in the designated room. In case if the user wants to enjoy the same broadcast service in a plurality of places (rooms), the user must connect a free end of the coaxial cable from the antenna to a distributor, extend a plurality of extension coaxial cables from the distributor to the respective rooms, connect the cables to the respective STBs and finally connect the respective STBs to respective TV receivers in the respective rooms.

In other words, when the user wants to receive a particular broadcast service at two or more separate places (rooms), he or she must connect two or more coaxial cables to a distributor coupled to a particular antenna for the particular broadcast service and bring the respective cables to the desired places provided each with a particular STB. This procedure must be repeated for each of different kinds of broadcasting services.

Problem (2): In case of concurrently enjoying the same broadcast service at two or more places (rooms), the user has to, as described before in the third procedure, purchase or lease a plurality of STBs designated by the relevant broadcasting company and provide one at each of desired places.

Namely, in case of making an arrangement enabling family members to concurrently view the same broadcast in different rooms, the user must solve the problem (1) and further purchase or lease a plurality of the same particular STBs.

Problem (3): In case of receiving broadcast services from a plurality of broadcasting companies, the user must purchase or lease a plurality of STBs from the corresponding broadcasting companies and it is bothering to arrange the STBs at different positions in the same room since they are different from one another in design and size.

### SUMMARY OF THE INVENTION

A primary object of the present invention is to provide a multi-broadcast receiving and distributing device which enables a user to construct a system for enjoying any desirable broadcast service of a particular broadcasting company at any desirable place only by conducting cable connection between an antenna for receiving the particular broadcast service signals and a STB capable of decoding the signals (STB will be hereinafter referred to as a receiver to avoid confusing it from the conventional device) without further wiring from the receiver to each display unit.

Another object of the present invention is to provide a multi-broadcast receiving and distributing device which enables a user to construct a system for enjoying any desirable broadcast service of a particular broadcasting company at a plurality of desirable places by purchasing or leasing only one particular receiver designated by the particular broadcasting company.

Another object of the present invention is to provide a multi-broadcast receiving and distributing device which enables a user to construct a system capable of receiving broadcasting services from a plurality of broadcasting companies by using only unified receivers of the same size and shape for the respective broadcasting companies.

Another object of the present invention is to provide a multi-broadcast receiving and distributing device that comprises a receiver having a function for receiving an inherent carrier signal of each broadcasting companies and converting them into output common baseband signals (e.g., MPEG-2 signals) and a device body having a plurality of spaces for accommodating a plurality of the receivers, which body obtains one or more kinds of particular broadcast information by processing the common baseband signals output from the receiver and delivers the information to a plurality of display units.

One unit of thus constructed multi-broadcast receiving and distributing device can accommodate therein a plurality of receivers for receiving carrier signals from plural respective broadcasting companies and deliver information to a plurality of display units disposed in desired rooms by using radio waves without wiring thereto.

Another object of the present invention is to provide a multi-broadcast receiving and distributing device capable of concurrently displaying broadcast programs from respective broadcasting companies on a plurality of display units, wherein broadcast signals from respective broadcasting companies can be converted into common type baseband signal (e.g., MPEG-2 signals) and transmitted to respective display units by providing the device with receivers one for each of respective broadcasting companies.

Another object of the present invention is to provide a multi-broadcast receiving and distributing device comprising a main body having a plurality of compartments (spaces) for accommodating a plurality of receivers specified by respective broadcasting companies, which compartments have the same size and same shape for an intention to require the broadcasting companies to make their receivers unified in size and shape and, on the other hand, allows any different size-and-shape receiver to fit therein with use of a fitting adaptor. This enables user to purchase or lease a most desirable one of available receivers by examining function, performance and expense of every receiver free from the size-and-shape problem.

Another object of the present invention is to provide a multi-broadcast receiving and distributing device comprising: one or more receivers provided each with one or more receiving means for receiving and extracting a carrier signal of broadcast programs or broadcast data transmitted based on inherent signal types from carrier signals and a signal converting means for converting the received carrier signal into a common signal type baseband signal; and a multi-broadcast receiving and distributing device body comprising one or more receiver accommodating means for accommodating one or more said receivers and being capable of outputting the baseband signal received from the signal converting means of the receiver, a signal processing means for generating a digital signal by processing the baseband signal outputted from the receiver accommodating means, a program selecting means for selectively outputting an output signal relevant to a particular broadcast program or broadcast data included in the digital signal generated by the signal processing means, a program transmitting means for transmitting the output signal from the program selecting means to one or more display units.

Another object of the present invention is to provide a multi-broadcast receiving and distributing device, wherein the program transmitting means comprises radio transmission means.

Another object of the present invention is to provide a multi-broadcast receiving and distributing device, wherein the receiver is provided with a first-connection means for connecting the receiver with an antenna or an outdoor cable for receiving the carrier signal transmitted based on an inherent signal type, a second-connection means for outputting the baseband signal to the signal processing means of the device body, and said device body is provided with a third-connection means for connecting itself to the second connection means to input the baseband signal to the signal processing means for one or more receiver accommodating means and, wherein, when the receiver separated from the device body is accommodated in the receiver accommodating means, the second connecting means and the third connecting means are connected with each other to input the baseband signal to the signal processing means.

Another object of the present invention is to provide a multi-broadcast receiving and distributing device, wherein one or more said receiver accommodating means are provided each with an insertion guide mechanism for preventing erroneous insertion of a receiver.

Another object of the present invention is to provide a multi-broadcast receiving and distributing device, wherein one or more said receiver accommodating means are provided each at its insertion inlet with a removable cover for protection against foreign matters.

Another object of the present invention is to provide a multi-broadcast receiving and distributing device, wherein receiver accommodation spaces of the receiver accommodating means have all the same shape and the same size.

Another object of the present invention is to provide a multi-broadcast receiving and distributing device, wherein the one or more said receiver accommodating means are provided each with a receiver ejection means for removing the receiver out of the receiver accommodating means.

Another object of the present invention is to provide a multi-broadcast receiving and distributing device, wherein the second connecting means and the third connecting means each comprise a plurality of connection terminals and connected at their terminals with each other and the device body is capable of identifying the type of the receiver accommodated therein by the provision of particular one of the connection terminals composing the second connecting means.

Another object of the present invention is to provide a multi-broadcast receiving and distributing device, wherein the receiver is provided with a mixed signal inputting means for inputting plural carrier signals mixed together and said means is disposed between the first connecting means and the signal converting means.

Another object of the present invention is to provide a multi-broadcast receiving and distributing device, wherein in the receiver, the mixed signal inputting means and the second connecting means are connected to each other, and the device body is provided with a fourth connection means for inputting a carrier signal different from a carrier signal of the first connection means and a signal distributing means for distributing the different carrier signal from the fourth connection means to a plurality of the third connection means provided one for each of the receiver accommodating means, and the different carrier signal from the fourth connection means is input via the signal distributing means, the third connection means and the second connection means to the mixed signal inputting means.

### BRIEF DESCRIPTION OF THE DRAWINGS

FIG. 1 shows the correct alignment of the drawing sheets for FIGS. 1A and 1B.

FIGS. 1A and 1B are construction block diagrams of a conventional indoor broadcast reception wiring arrangements.

FIG. 2 shows the correct alignment of the drawing sheets for FIGS. 2A and 2B.

FIGS. 2A and 2B are construction views of a multi-broadcast receiving and distributing device system according to an embodiment of the present invention.

FIG. 3 is a schematic front view of a receiver accommodating portion of a multi-broadcast receiving and distributing device according to an embodiment of the present invention.

FIG. 4 illustrates an exemplary connection terminal unit of the second connecting terminal.

FIG. 5 is a construction view of a digital broadcast receiver of a multi-broadcast receiving and distributing device according to another embodiment of the present invention.

FIG. 6 is a construction view of an analog broadcast receiver of a multi-broadcast receiving and distributing device according to another embodiment of the present invention.

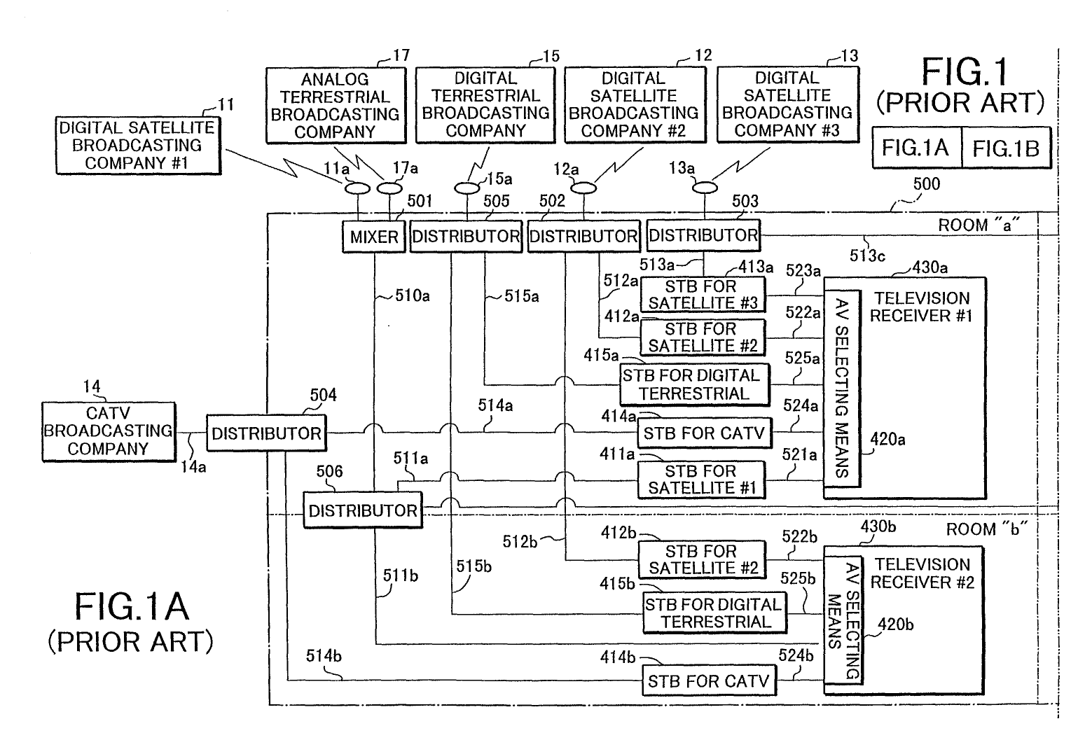

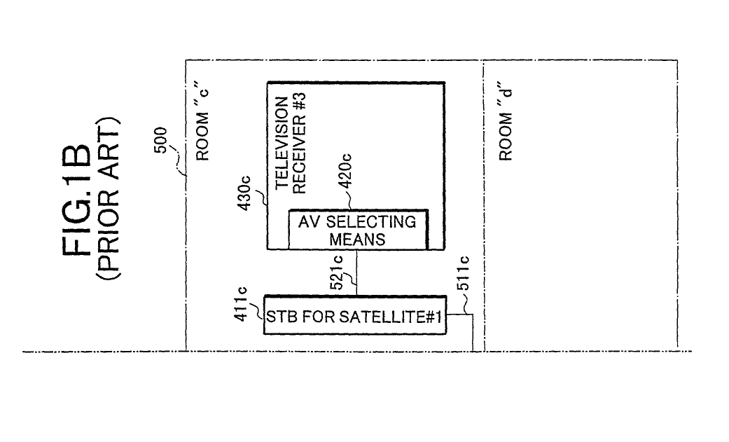

### PREFERRED EMBODIMENT OF THE INVENTION

A preferred embodiment of the present invention will be described bellow with reference to the accompanying drawings.

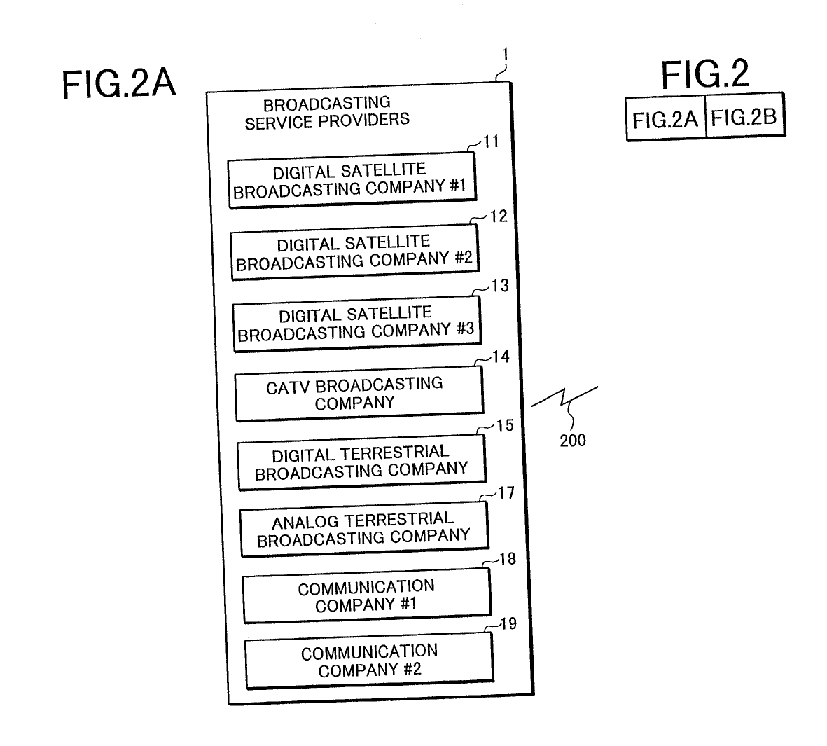

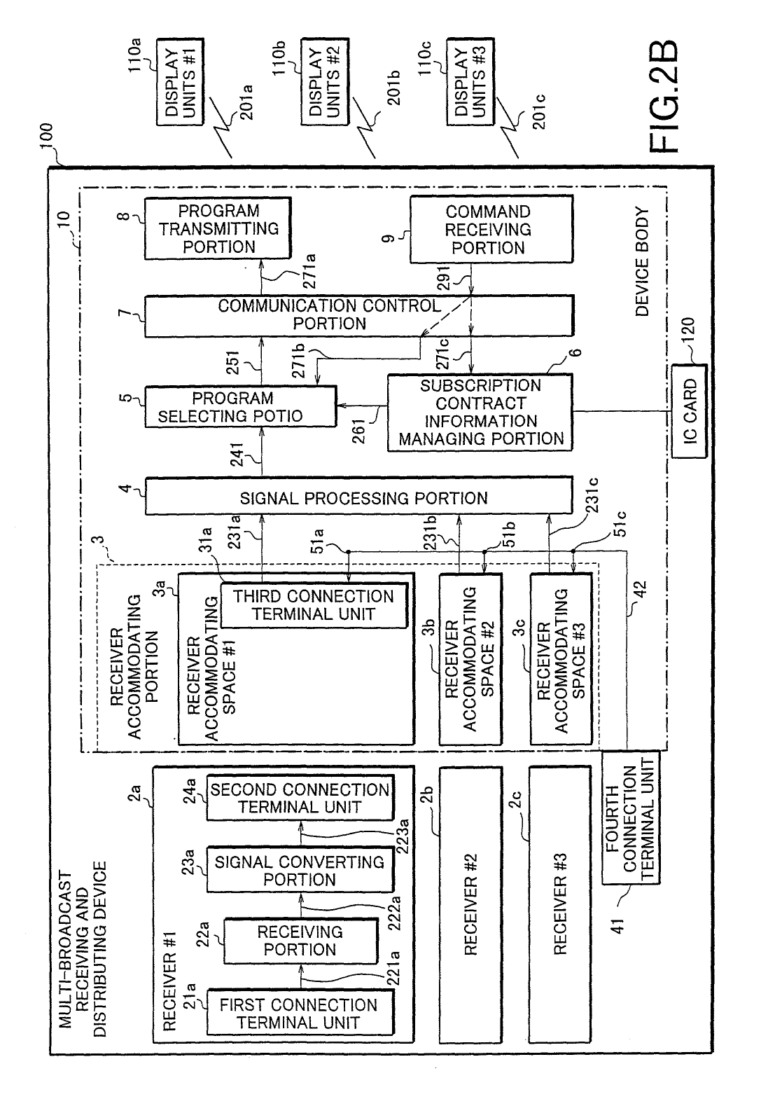

In FIG. 2, numeral 1 denotes broadcasting service providers (broadcasting company) including a first digital satellite broadcasting company 11, a second digital satellite broadcasting company 12, a third digital satellite broadcasting company 13, a CATV broadcasting company 14, a digital terrestrial broadcasting company 15, an analog terrestrial broadcasting company 17, a first communication company (carrier) 18 and second communication company (carrier) 19, which include special type II carrier and general type II carrier. Numeral 200 denotes carrier signals of particular frequencies assigned to respective broadcasting companies 1, which the broadcasting companies 1 use in order to transmit a plural of broadcast programs and data information to user.

Numerals 2a, 2b and 2c designate receivers #1, #2 and #3 respectively, each of which is provided with a first connection terminal unit (21a, 21b, 21c) composing a terminal unit coupled with an antenna or an outdoor cable for receiving a particular carrier signal 200 of a broadcasting company with which a user has concluded a subscription contract (hereinafter referred to as “contractor-company”), a receiving portion (22a, 22b, 22c) for extracting a carrier signal inherent to the broadcasting contractor-company from the carrier signals received from the first connection terminal unit (21a, 21b, 21c), a signal converting portion (23a, 23b, 23c) for converting the each extracted carrier signal into a common digital baseband signal (e.g., MPEG-2 signals) and a second connection terminal unit (24a, 24b, 24c) for outputting the common baseband signal. In FIG. 2, the components (i.e., the first connection terminal unit 21a, the receiving portion 22a, the signal converting portion 23a and the second connection terminal unit 24a of the receiver #1 (2a) are illustrated but the similar components of the receivers #2 and #3 are not shown.

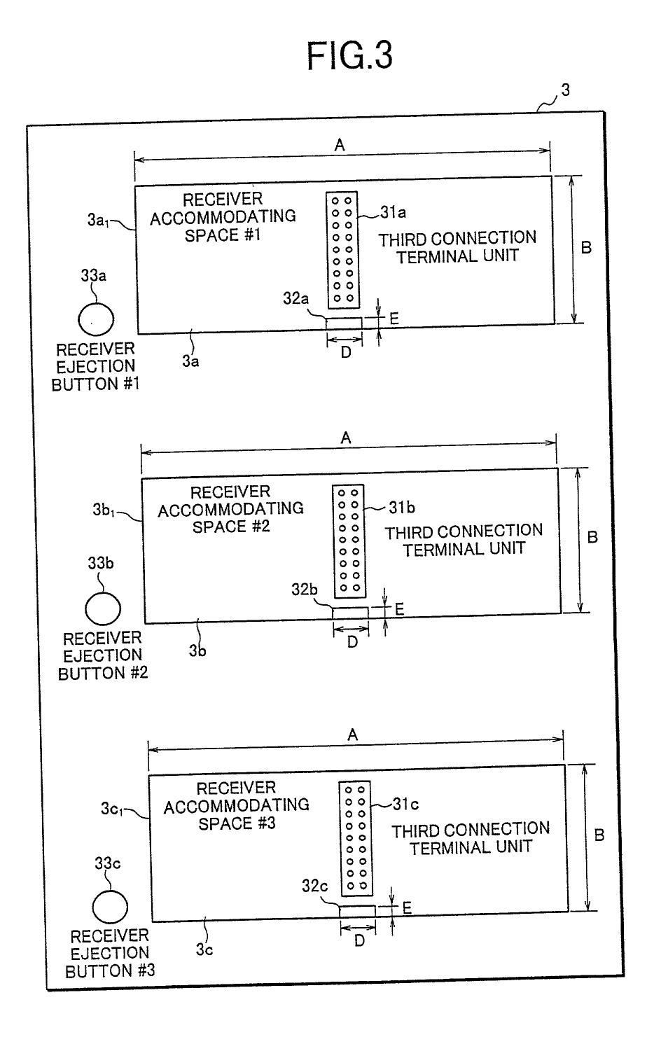

A device body 10 of the multi-broadcast receiving and distributing device 100 is composed of a receiver accommodating portion 3 having one or more receiver-accommodating compartments (spaces) #1 (3a), #2 (3b) and #3 (3c) provided with third-connection terminal units 31a, 31b, 31c (the third-connection terminal units 31b and 31c are shown in FIG. 3) respectively for connecting thereto the second connection terminal unit 24a, 24b, 24c, respectively, of the receivers #1 (2a), #2 (2b), #3 (2c) accommodated therein, a signal processing portion 4 for extracting, as outputs 231a, 231b and 231c via the second connection terminal unit 24a, 24b and 24c and the third connection terminal unit 31a, 31b and 31c, the common baseband signals 223a, 223b and 223c (baseband signals 223b and 223c are not shown) output from the signal conversion portions 23a, 23b and 23c of the receivers #1, #2 and #3 and generating error-corrected received signals by processing the extracted common baseband signals, a program selecting portion 5 for selecting a received signal 251 relevant to a particular program specified by a program selection command transmitted from one of display units #1 (110a), #2 (110b) and #3 (110c), a program transmitting portion 8 for transmitting the received signal 251 from the program selecting portion 5, which is relevant to the particular broadcast program, to one of the display units #1 (110a), #2 (110b) and #3 (110c) through the communication control portion 7, a command receiving portion 9 for receiving command signals from one or more display units #1 (110a), #2 (110b) and #3 (110c), a communication control portion 7 for controlling communications between the program transmitting portion 8, the command receiving portion 9 and the display units #1 (110a), #2 (110b) and #3 (110c), and subscription contract information managing portion 6 for managing information on a subscription contract with a broadcasting company, which is recorded on an IC card 120.

Transmission of information between the program transmitting portion 8 and the display units #1 (110a), #2 (110b) and #3 (110c) and between the command receiving portion 9 and the display units may be realized by using radio and/or cables.

Numeral 100 designates a multi-broadcast receiving and distributing device comprising a device body 10 and one or more receivers #1 (2a), #2 (2b) and #3 (2c).

The operation of the multi-broadcast receiving and distributing device 100 embodying the present invention is as follows:

A user selects a preferred broadcasting company from a group of broadcast companies 1 shown in FIG. 2, installs an antenna or an outdoor cable for receiving the broadcast signals provided by the selected broadcasting company and purchases or rents a receiver specified by the broadcasting company. When the user selected a plurality of broadcasting companies, the user purchases or leases specified receiver for each of the selected companies. The user disposes the receivers #1 (2a), #2 (2b) and #3 (2c) in the spaces (compartments) #1 (3a), #2 (3b) and #3 (3c) of the receiver accommodating portion 3 of the multi-broadcast receiving and distributing device body 10.

For example, the receiver accommodating portion 3 of the device body 10 has three (3) spaces #1 (3a), #2 (3b) and #3 (3c) for mounting the receivers #1 (2a), #2 (2b) and #3 (2c) respectively. The multi-broadcast receiving and distributing device body 10 can receive broadcast signals provided by the respective broadcasting companies when the second connection terminal units 24a, 24b and 24c of the receivers #1 (2a), #2 (2b) and #3 (2c) mounted in spaces #1 (3a), #2 (3b) and #3 (3c) respectively are electrically connected with the third connection terminal units 31a, 31b and 31c, respectively, of the device body 10.

The receivers #1 (2a),#2 (2b) and #3 (2c) process the received signals in different ways depending on different carrier signals of the broadcasting companies but in the same procedure. Namely, the broadcasting companies transmit a number of broadcast programs or information as carrier signals 200 of specified frequencies by using radio waves or a cable. The carrier signals 200 of specified frequencies are received by the antenna or via the outdoor cable and then through the first connection terminal unit 21a, 21b and 21c connected to the antenna or the cable is inputted as carrier signals 221a, 221b and 221c to the receiving portions 22a, 22b and 22c, respectively, of the receivers #1 (2a), #2 (2b) and #3 (2c). The particular carrier signals 222a, 222b (not shown) and 222c (not shown) of specified frequency bands of the broadcasting companies selected by the user are selectively extracted from the carrier signals 221a, 221b (not shown) and 221c (not shown) having different frequency bands for respective broadcasting companies and then inputted to the signal converting portions 23a, 23b and 23c.

In the signal converting portion 23a, 23b and 23c, the input carrier signals 222a, 222b and 222c are converted to baseband signals 223a, 223b and 223c having a common digital signal form (e.g., MPEG-2 type signal) and then outputted to the second connection terminal unit 24a, 24b and 24c. Since the receivers #1 (2a), #2 (2b) and #3 (2c) are mounted in the spaces #1 (3a), #2 (3b) and #3 (3c) respectively and their second connection terminal unit 24a, 24b and 24c are electrically connected to the third connection terminal unit 31a, 31b and 31c respectively, output signals of the second terminals 24a, 24b and 24c can appear as output signals 231a, 231b and 231c respectively at the third terminals 31a, 31b and 31c, which therefore correspond to the digital baseband signals 223a, 223b and 223c respectively.

The common digital baseband signals 231a, 231b and 231c output from the spaces #1 (3a), #2 (3b) and #3 (3c) are transferred to the signal processing portion 4 where they are corrected for errors caused from the interfering waves during the transmission and then outputted therefrom as a received signal 241 in which a number of broadcast programs, broadcast data and individual information or various services provided by the selected broadcasting companies are multiplexed.

The program selecting portion 5 has a program selecting circuit and a descrambling circuit. The program selecting circuit identifies a particular program, data or service specified by the user based on a program selection signal 271b corresponding to a channel signal 291 from the command receiving portion 9 via the communications control portion 7 and selects a signal relevant to the specified program, data or service from the received multiplexed signal 241. If the selected signal has been scrambled, the descrambling circuit reads out key information from an IC card 120 through the subscription information managing portion 6, descrambles the selected signal and generates a viewable received signal 251. In other words, the program selecting circuit is used for selecting from the received signal 241 a signal relevant to a particular program, data or service specified by the user and the descrambling circuit is used if the relevant signal has been scrambled.

The received signal 241 has a digital signal form common to broadcasting information of all broadcasting companies and requires no special processing for every company.

On the other hand, the channel signal 291, which is received in the command receiving portion 9, representing the user's command for selecting the particular program, data or service is divided via the communications control portion 7 into two signals, i.e., program selection signal 271b and disclosure deciding signal 271c. The program selection signal 271b is input to the program selecting portion 5 whereby it is used for selecting the particular signal relevant to the particular program, data or service required by the user as described before. The disclosure deciding signal 271c is input to the subscription contract information managing portion 6 that in turn decides whether the signal relevant to the particular program, data or service required by the user corresponds to the channel that can be disclosed to the user under the subscription contract and finally transfers a disclosure deciding signal 261 to the program selecting portion 5. If the signal 261 indicates the disclosability of the channel, the signal relevant to the particular program, data or service, which was selected by a program selecting circuit of the program selecting portion 5 based on the program selecting signal 271b, is transferred to the descrambling circuit, wherefrom the descrambled received signal 251 is transmitted to the communications control portion 7.

As described before, the received signal 251 has a digital signal form common to all broadcast information of respective broadcasting companies and therefore has no necessity of specially processing for every companies.

The communications control portion 7 generates a received signal 271a with a tag data attached thereto in such a manner that an identification number of one of the display units #1 (110a), #2 (110b) and #3 (110c) sending the channel signal 291 required by the user is added as a tag data to the received signal 251. The generated signal 271a is then transferred to the program transmitting portion 8 that in turn identifies the objective one of the display units #1 (110a), #2 (110b) and #3 (110c) by the tag number of the received signal 271a and transmits one of radio signals (or cable signal) 201a, 201b, 201c to the objective display unit. In case when a plurality of the display units are requiring the simultaneous transmission of the same program data or service information, the transmitting portion 8 transmits the same program data or service information via radio or a cable to the requiring units.

As described above, the multi-broadcast receiving and distributing device 100 according to the present invention can transmit one or more programs, data or service information provided by one or more broadcasting companies selected by the user to one or more display units only by accommodating therein receivers specified by the respective broadcasting companies.

The construction of a receiver-accommodating portion of the multi-broadcast receiving and distributing device 100 according to the present invention is described below. FIG. 3 is a schematic front view of the receiver-accommodating portion 3 of the multi-broadcast receiving and distributing device 100 according to the present invention.

In FIG. 3, oblong holes 3a₁, 3b₁ and 3c₁ are receiver insertion inlets of the receiver-accommodating spaces #1 (3a), #2 (3b) and #3 (3c). Namely, each of spaces #1 (3a), #2 (3b) and #3 (3c) forms a cuboidal space (compartment). Guides 32a, 32b and 32c are provided for protection against erroneous insertion of respective receivers #1 (2a), #2 (2b) and #3 (2c) into the spaces #1 (3a), #2 (3b) and #3 (3c) respectively. Each guide is a cuboidal protrusion on which the receiver slidably fit at its bottom groove. Buttons 33a, 33b and 33c are used for ejecting the respective receivers #1 (2a), #2 (2b) and #3 (2c) from the respective spaces #1 (3a), #2 (3b) and #3 (3c). Connection terminal unit 31a, 31b and 31c are the third connection terminal unit shown in FIG. 2 and each of them is provided on a back inner wall of each space. When the receivers #1 (2a), #2 (2b) and #3 (2c) are inserted completely into the respective spaces #1 (3a), #2 (3b) and #3 (3c), the second connection terminal unit 24a, 24b and 24c of the respective receivers #1 (2a), #2 (2b) and #3 (2c) are electrically connected with the third connection terminal unit 31a, 31b and 31c respectively. The above-described construction of the receiver accommodating portion 3 is merely an example and not limited to. For example, the insertion hole may have different shape (e.g., vertically long or square) other than oblong shape and the insertion guide may be made not on the bottom but on the side or top wall of the space.

Referring to FIG. 3, the construction of the receiver accommodating spaces (compartments) #1 (3a), #2 (3b) and #3 (3c) is described below in detail.

The size and shape of the compartments #1 (3a), #2 (3b) and #3 (3c) (Width×Height×Depth: A×B×C) are the same to each other and the size and shape of the insertion guides 32a, 32b and 32c (Width×Height×Depth: D×E×F) are the same to each other. This enables the user to place any receiver of any broadcasting company in any one of the compartments of the device. The unified compartments require manufacturers to provide the receivers unified in size and shape for all broadcasting companies. This may also force the manufacturers to give features to their products in function, performance and cost (not in size and shape). On the contrary, the users may have a good chance to acquire a more adaptive one from available receivers by examining function, performance and expense of the receivers being free from the size-and shape problem. A preferable receiver having a different particular shape and size may be mounted in the compartment by using an adaptor giving the receiver the unified size and shape necessary for mounting therein. The adaptor shall be also provided by the manufacturer of the receiver.

The insertion guides 32a, 32b and 32c formed on the respective compartments serve as the protection of erroneous insertion of the receivers into the respective compartments since each receiver may be inserted into an inlet (3a₁, 3b₁ or 3c₁) in such a manner that it slidably fits at its bottom groove on the guide (32a, 32b or 32c).

The inlets (3a₁, 3b₁, 3c₁) of the receiver accommodating compartments are provided each with a cover with a spring or a gear, which shuts off the inlet (3a₁, 3b₁ or 3c₁) while the compartment is vacant (i.e., no receiver mounted therein). This can eliminate the entry of dust and dirt into the inside of the multi-broadcast receiving and distributing device 100 through the receiver accommodating spaces, thus reducing the trouble occurrence frequency.

The receiver ejecting buttons 33a, 33b and 33c are used for manually or automatically separating the electrical connection of the second connection terminal unit 24a, 24b, 24c of the receivers (as shown in FIG. 2) from the third connection terminal unit 31a, 31b, 31c of the device body 10. Pressing the ejection button (33a, 33b, 33c) causes the connection terminal unit of the receiver to be separated from the connection terminal unit of the device body. Then, the receiver can be easily removed out of the space. For example, in the case user changes a broadcasting company to another one, it is easy to replace a receiver with another receiver by using the ejection button 33a, 33b or 33c.

The receiver accommodating spaces #1 (3a), #2 (3b), #3 (3c) have the third connection terminal units 31a, 31b and 31c respectively, all of which have the same shape, contact arrangement thereon and mounted position in the space. Therefore, the receivers mountable in the device body 10 shall have the second connection terminal units 24a, 24b, 24c that are the same in shape, arrangement and position each other and may fit in the third connection terminal units 31a, 31b, 31c respectively to create the electric connection. Consequently, irrespective of the broadcasting companies or receiver manufacturers, the user can mount the receivers having the same configuration and the same connection terminal unit in the multi-broadcast receiving and distributing device body 10 and electrically connect the receiver to the device body.

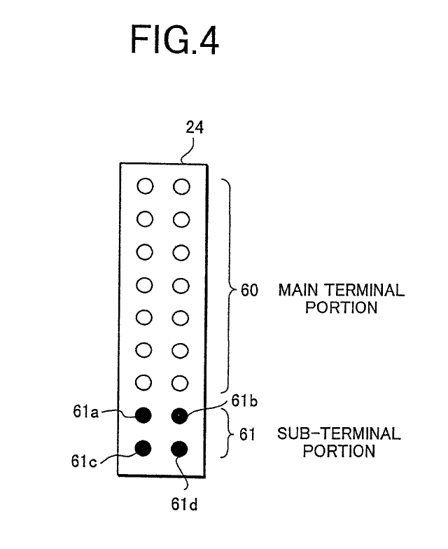

Each of the second connection terminal unit (24a, 24b, 24c) of the receivers has the same arrangement of terminals thereon, which includes terminals representing the classification of the receiver, i.e., a particular kind of broadcasting service that can be received via the receiver. Referring to FIG. 4, the method of identifying the classification of the receiver is described below.

FIG. 4 is illustrative of an exemplary arrangement of terminals on the second connection terminal unit. In FIG. 4, a terminal unit 24 (24a, 24b, 24c) of the receiver (2a, 2b, 2c) has a main terminal portion 60 for outputting a common digital baseband signal and inputting and outputting various kinds electric signals (commands, power supply, ground signal and so on), which are necessary for operating the receiver (2a, 2b, 2c), and a sub-terminal portion 61 for representing kinds of broadcasting services that can be received via the receiver. The sub-terminal portion 61 is composed of sub-terminals 61a, 61b, 61c and 61d. The classification of the broadcasting services to be received via the receiver can be indicated by the provision of the sub-terminals 61a, 61b, 61c and 61d or a combination of electric connections of the sub-terminals.

For example, 4 sub-terminals 61a, 61b, 61c and 61d shown in FIG. 4 are given specified meanings of their positions. For example, the provision of only the sub-terminal 61a designates the receiver for receiving analog terrestrial broadcasts and the provision of sub-terminals 61a and 61d designates the receiver for receiving digital satellite broadcasts.

There may be 16 combinations of provisions or electrical connections of 4 sub-terminals. In other words, 16 kinds of broadcasting services can be defined by 16 respective sub-terminal patterns.

When the second connection terminal unit (24a, 24b, 24c) with sub-terminals 61a, 61b, 61c and 61d of the receiver is electrically connected to the third connection terminal unit (31a, 31b, 31c) of the receiver accommodating space of the multi-broadcast receiving and distributing device body 10, the device body 10 via the third connection terminal unit (31a, 31b, 31c) electrically connected to the second connection terminal unit (24a, 24b, 24c) of the receiver reads the state of the sub-terminals 61a, 61b, 61c and 61d of the second connection terminal unit and recognizes the kind of broadcasting service to be received via the receiver, i.e., the classification of the receiver.

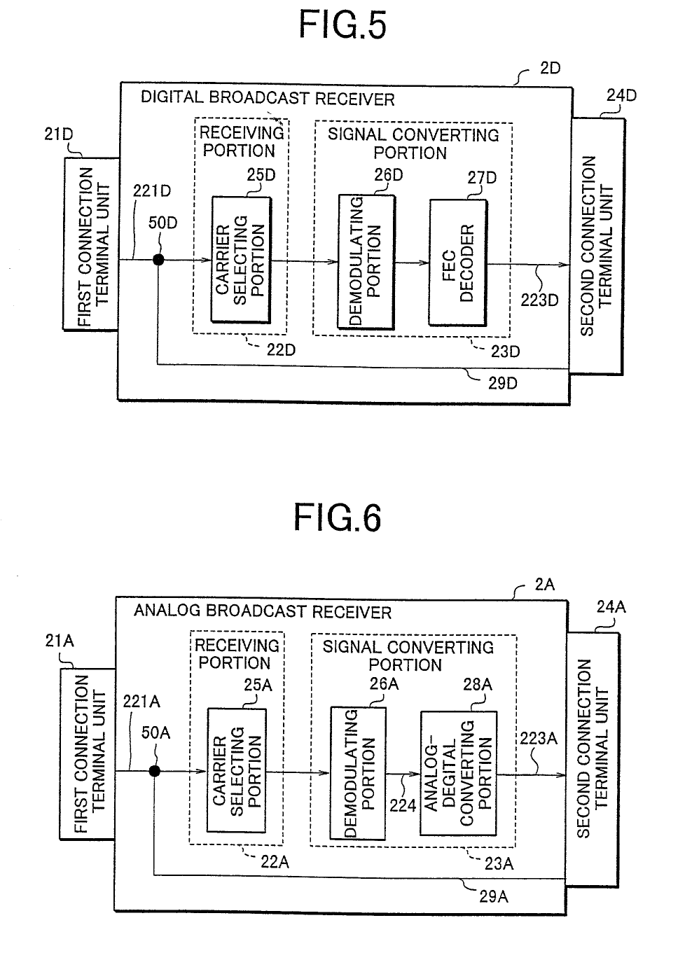

FIGS. 5 and 6 show construction views of a digital broadcast receiver and an analog broadcast receiver, respectively, which are used in a multi-broadcast receiving and distributing device according to another embodiment of the present invention. In this embodiment, the receivers are provided each with a mixed signal inputting means for inputting a plurality of carrier signals mixed together.

In FIG. 5, a digital broadcast receiver 2D comprises a first-connection terminal 21D for connection with an antenna or an outdoor cable for receiving carrier signals provided by digital broadcasting companies, a receiving portion 22D having a carrier selecting portion 25D for extracting a carrier signal of a particular broadcasting company from the signals received via the antenna or the cable, a signal converting portion 23D for converting the extracted carrier signal into a common digital baseband signal and having a demodulating portion 26D and FEC (Forward Error Correction) decoder 27D, a second-connection terminal unit 24D for outputting the common baseband signal and a tap 50D for mixing together carrier signals from the antenna or the cable and inputting the mixed signals via a particular terminal of the first connection terminal unit 21D and a particular terminal of the second connection terminal unit 24D to the carrier selecting portion 25D. In FIG. 5, there is shown a carrier signal 221D and a baseband signal 223D.

In FIG. 6, an analog broadcast receiver 2A is provided with a first-connection terminal unit 21A for connecting to an antenna or an outdoor cable for receiving carrier signals provided by analog broadcasting companies, a receiving portion 22A having a carrier selecting portion 25A for extracting a carrier signal of a particular broadcasting company from the signals received via the antenna or the cable, a signal converting portion 23A for converting the extracted carrier signal into a common digital baseband signal and having a demodulating portion 26A and an analog-digital converting portion 28A, a second-connection terminal unit 24A for outputting the common baseband signal and a tap 50A for mixing together carrier signals from the antenna or the cable and inputting the mixed signals via a particular terminal of the first connection terminal unit 21A and a particular terminal of the second connection terminal unit 24A to the carrier selecting portion 25A. In FIG. 6, there is also shown a carrier signal 221A, a baseband signal 223A and an analog baseband signal 224.

A mixed signal inputting means used in the embodiment of the present invention is described below with reference to FIGS. 2, 5 and 6. As shown in FIG. 2, the multi-broadcast receiving and distributing device body 10 contains a fourth connection terminal unit 41 for inputting an external signal, a connection cable 42 connected to the fourth connection terminal unit 41 and taps 51a, 51b and 51c on the connection cable 42. The taps 51a, 51b and 51c are connected to respective particular terminals of the third-connection terminal units 31a, 31b and 31c of the receiver-accommodating spaces #1 (2a), #2 (2b) and #3 (2c). As shown in FIGS. 5 an 6, a connection cable 29D (29A) serving as a means for mixing a plurality of carrier signals is provided between a particular terminal of the second connection terminal unit 24D (24A) of the receiver 2D (2A) and a tap 50D (50A) in order to provide the receiving portion 22D (22A) with another carrier signal inputted via the particular terminal of the third connection terminal unit (31a, 31b and 31c) to the particular terminal of the second connection terminal unit 24D (24A).

In case of applying a receiver capable of mixing different carrier signals from a plurality of antennas of broadcasting companies, besides the antenna connected to the first connection terminal unit, another antenna for receiving carrier signal from another broadcasting company is connected via a connection cable to the fourth connection terminal unit 41. A carrier signal from another broadcasting company is thus supplied over the cable 42 in the device body 10. The carrier signal from the broadcasting company is supplied via one of the taps (51a, 51b and 51c) to a particular terminal of the third connection terminal unit (31a, 31b and 31c) in the receiver accommodating space (#1 (3a), #2 (3b) and #3 (3c)).

For example, when a digital broadcast receiver 2D capable of receiving a carrier signal from a particular broadcasting company via the fourth connection terminal unit 41 is mounted in the receiver accommodating space #1 (3a), a particular frequency carrier signal 200 broadcast by the broadcasting company is transferred via the fourth connection terminal unit 41, the connection cable 42, the tap 51a, the particular terminal of the third connection terminal unit 31a to the particular terminal of the second connection terminal unit 24D in the digital broadcast receiver 2D and then supplied via the connection cable 29D and tap 50D to the receiving portion 22D. Namely, another desirable carrier signal besides a carrier signal via the first connection terminal unit 21D can be received by connecting a connection cable or an extension of the outdoor cable to the fourth connection terminal unit 41.

According to the present invention, the following advantages can be obtained.

The multi-broadcast receiving and distributing device according to the present invention can accommodate in its body one or more receivers for receiving one or more broadcasting companies selected by the user, one for each company, convert broadcast signals from the broadcasting companies into common digital signals and process the common digital signals therein and distribute broadcast programs, data and service information supplied by respective broadcasting companies to one or more display units without installing special wiring for each broadcasting company. This enables the user to easily construct a system for viewing broadcasting programs of a particular broadcasting company at desirable places by installing a special antenna arrangement for the broadcasting services, mounting a particular receiver in the device body and connecting the antenna to the receiver by using a connection cable.

When the user wants to construct a viewing system allowing a plurality of viewers to simultaneously enjoy a particular broadcasting service at a plurality of desired places by purchasing or leasing only one set of receiver specially used for a broadcasting company providing the broadcasting service.

Application of all unified in shape-and-size receivers specially used for respective broadcasting companies enables the users to select the most suited one of available receivers for each broadcasting service from view point of functions, performance and expense to purchase or lease.

1. A multi-broadcast receiving and distributing device comprising:
one or more receivers provided each with one or more receiving means for receiving and extracting a carrier signal of broadcast programs or broadcast data transmitted based on inherent signal types from carrier signals and a signal converting means for converting the received carrier signal into a common signal type baseband signal; and
a multi-broadcast receiving and distributing device body comprising one or more receiver accommodating means for accommodating one or more said receivers and being capable of outputting the baseband signal received from the signal converting means of the receiver, a signal processing means for generating a digital signal by processing the baseband signal outputted from the receiver accommodating means, a program selecting means for selectively outputting an output signal relevant to a particular broadcast program or broadcast data included in the digital signal generated by the signal processing means, a program transmitting means for transmitting the output signal from the program selecting means to one or more display units.

2. A multi-broadcast receiving and distributing device as defined in claim 1, wherein the program transmitting means comprises radio transmission means.

3. A multi-broadcast receiving and distributing device as defined in claim 1 or 2, wherein the receiver is provided with a first-connection means for connecting the receiver with an antenna or an outdoor cable for receiving the carrier signal transmitted based on an inherent signal type, a second-connection means for outputting the baseband signal to the signal processing means of the device body, and said device body is provided with a third-connection means for connecting itself to the second connection means to input the baseband signal to the signal processing means for one or more receiver accommodating means and, wherein, when the receiver separated from the device body is accommodated in the receiver accommodating means, the second connecting means and the third connecting means are connected with each other to input the baseband signal to the signal processing means.

4. A multi-broadcast receiving and distributing device as defined in any one of claims 1 to 3, wherein one or more said receiver accommodating means are provided each with an insertion guide mechanism for preventing erroneous insertion of a receiver.

5. A multi-broadcast receiving and distributing device as defined in any one of claims 1 to 4, wherein one or more said receiver accommodating means are provided each at its insertion inlet with a removable cover for protection against foreign matters.

6. A multi-broadcast receiving and distributing device as defined in any one of claims 1 to 5, wherein receiver accommodation spaces of the receiver accommodating means have all the same shape and the same size.

7. A multi-broadcast receiving and distributing device as defined in any one of claims 1 to 6, wherein the one or more said receiver accommodating means are provided each with a receiver ejection means for removing the receiver out of the receiver accommodating means.

8. A multi-broadcast receiving and distributing device as defined in any one of claims 3 to 7, wherein the second connecting means and the third connecting means each comprise a plurality of connection terminals and connected at their terminals with each other and the device body is capable of identifying the type of the receiver accommodated therein by the provision of particular one of the connection terminals composing the second connecting means.

9. A multi-broadcast receiving and distributing device as defined in any one of claims 3 to 8, wherein the receiver is provided with a mixed signal inputting means for inputting plural carrier signals mixed together and said means is disposed between the first connecting means and the signal converting means.

10. A multi-broadcast receiving and distributing device as defined in claim 9, wherein in the receiver, the mixed signal inputting means and the second connecting means are connected to each other, and the device body is provided with a fourth connection means for inputting a carrier signal different from a carrier signal of the first connection means and a signal distributing means for distributing the different carrier signal from the fourth connection means to a plurality of the third connection means provided one for each of the receiver accommodating means, and the different carrier signal from the fourth connection means is input via the signal distributing means, the third connection means and the second connection means to the mixed signal inputting means.
